(19) United States
(12) Patent Application Publication
(10) Pub. No.: US 2025/0033723 A1
(43) Pub. Date: Jan. 30, 2025

(54) ACTUATOR SYSTEM LOCATED ON THE BOTTOM OF SEATPOST FOR BICYCLE

(71) Applicants: PAUL DAVID GALLAGHER, BURKESVILLE, KY (US); CRANKING SOLUTIONS CO., LTD, TAINAN CITY (TW)

(72) Inventors: PAUL DAVID GALLAGHER, BURKESVILLE, KY (US); HOU CHIEN CHIH, TAINAN CITY (TW); SACK STEFAN, STEGAURACH (DE)

(21) Appl. No.: 18/780,830

(22) Filed: Jul. 23, 2024

Related U.S. Application Data
(60) Provisional application No. 63/515,597, filed on Jul. 26, 2023.

(51) Int. Cl. B62J 1/08

(52) U.S. Cl. CPC B62J 1/08; B62J 2001/085

(57) ABSTRACT

An actuator system for height adjustment of a bicycle telescopic seat post includes a motor and a lead screw. The lead screw drives an internal pushrod, which compresses a hydraulic release button at a bottom of the seat post to cause the seat post to move up and down linearly. With a compact design, the actuator can be enclosed in a very small device and is mounted at the bottom of the seat post. The actuator is completely located within the bicycle seat tube.

### FIELD OF THE INVENTION

The present invention generally relates to bicycles, and more specifically, to an actuator system for controlling the seat height position of a telescopic seat post.

### BACKGROUND OF THE INVENTION

Most modern bicycles designed for off-road use have adjustable height seat posts. The adjustment method is similar to an office chair, and has a lever on the side that can unlock the mechanism to allow gas or spring pressure to push upwards. When the mechanism is unlocked, the user's weight is used to compress the spring or gas, and conversely, when they stand up, the seat rises. However, on bicycles, the control lever is usually located on the handlebars. This requires a long cable to connect to the seat post. Additionally, wireless control systems do not require cables and are easier to assemble and maintain.

The biggest challenge for electric actuators is their large size and the limited available space. The electric actuators are generally located under the seat and protrude from the rear of the seat post, which is not aesthetically pleasing.

At the same time, electric actuators are easily damaged by debris sprayed from the tires. Besides, the electric actuators may also come into contact with the rear tire during full suspension travel.

### SUMMARY OF THE INVENTION

The present invention relates to an actuator system for height adjustment of a bicycle seat post and provides an actuator located at a bottom of the bicycle seat post to raise and lower the seat post. The actuator system is compact and can be enclosed in a very small device that can fit into bicycle seat tube with an inner diameter as small as 27 mm. The compact design keeps the total length below 50 mm. A shorter length is crucial because any design that wastes space at the bottom would make the overall design meaningless by reducing the seat tube travel length.

The present invention further elaborates on a method to bring wireless radio signals to the exterior of the bicycle frame, allowing the motor to be positioned inside the bicycle frame.

The actuator system includes a motor and a lead screw, where the lead screw drives an internal pushrod that compresses a hydraulic release button at the bottom of the seat post. The actuator device is mounted at the bottom of the seat post, completely within the bicycle frame.

The present invention uses a unique system to record the position of the linear actuator. The circuit board includes two Hall sensors, and the lead screw has a charged magnet ring. As the lead screw rotates, the two Hall sensors detect the sinusoidal waves generated by the magnet ring. Then, a magnetic induction translator on the circuit board uses algorithms to accurately detect and calculate the precise position of the actuator nut on the lead screw. This can typically detect rotations accurate to within approximately 1 degree.

Although the present invention uses a lead screw and an actuator nut to open the valve, other alternative designs can also be used, such as:
A. Cam: Eccentric cams can be used to open the valve;
B. Lever: A central lever can open the valve, activated by a cam or lead screw;
C. Solenoid valve: Electromagnetic valves with sufficient magnetic force can also be used to open the valve, and
D. Wired version: Especially on battery-powered bicycles, both wired and wireless versions can be used.

Compared to existing technologies, the present invention has several significant advantages:

1. Cost significantly lower than existing technologies: Cost is crucial for achieving large-scale production and OEM markets. Known technologies are quite expensive and not suitable for the mass market. The present invention utilizes all existing seat post components currently in production, with only minimal modifications to the outer tube of the seat post. It can be easily retrofitted onto existing seat posts at minimal cost.

2. Compactness: The present invention is very space-saving and structurally compact, with the motor and lead screw located at the bottom of the seat post, fitting within an inner diameter of 27 mm.

3. Lighter weight compared to existing technologies: Although there is a slight increase in weight due to the motor and battery, eliminating cables and mechanical actuators results in an overall lighter weight.

4. Easy maintenance: Maintenance was considered during the design phase of the present invention. The actuator unit is connected by a single attachment screw, which can be replaced in minutes. All internal components of the actuator unit, including the battery, are replaceable.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the seat post of the present invention;

FIG. 2 is a perspective view of the exterior of the actuator device of the present invention;

FIG. 3 is a perspective view of the interior of the actuator device of the present invention, and

FIG. 4 is a partial perspective view of the seat post of the present invention.

### DETAILED DESCRIPTION OF THE PREFERRED EMBODIMENT

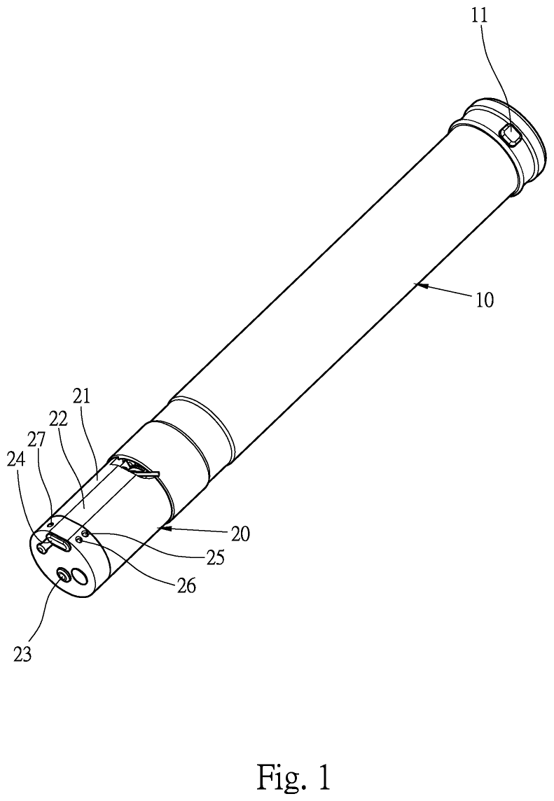

FIG. 1 is an overall perspective view of the seat post of the present invention, and comprises the seat post (10), an antenna (11), an actuator device (20), an actuator housing (21), an antenna connector cover (22), an attachment screw (23), a USB charging port (24), a charging LED (25), a status LED (26), and a reset button (27). The seat post (10) is inserted within the seat tube of the bicycle frame. Therefore, the actuator device (20) is located inside the bicycle frame, and depending on the frame material, the RF signal will be reduced or completely lost. The RF signal is routed from the actuator device (20) to the external antenna (11) through a coaxial cable. In this embodiment, we use a chip antenna, but any type of antenna can be used.

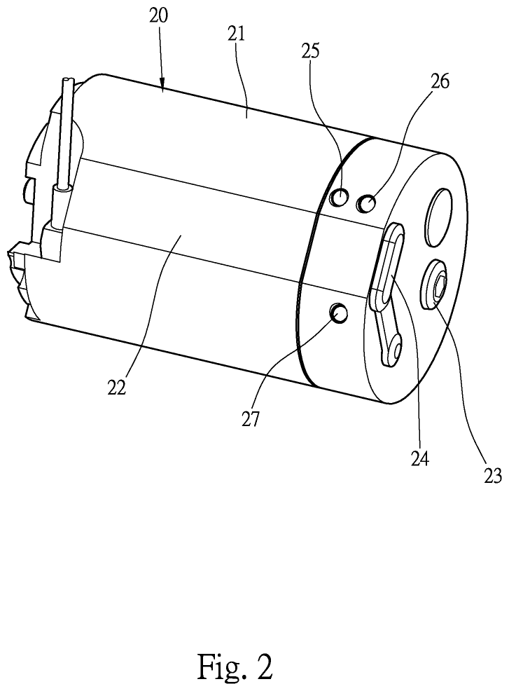

FIG. 2 is a perspective view of the actuator device of the present invention. The actuator housing (21) has an antenna connector cover (22) to facilitate connecting the antenna to the circuit board. To disassemble the actuator unit, the antenna connector cover (22) needs to be removed first, then the coaxial antenna cable is unplugged from the circuit board. The actuator unit is located at the bottom of the seat post, with the coaxial antenna cable connecting from the circuit board of the actuator unit to the external antenna. Also visible is one end of the attachment screw (23), which is used to fix the actuator device (20) to the seat post. The USB charging port (24) is used to charge the battery associated with the actuator system, with the charging LED (25) indicating the charging status. The status LED (26) provides a visual indication of the operating status of the actuator system. The reset button (27) can reset the actuator system to its factory settings.

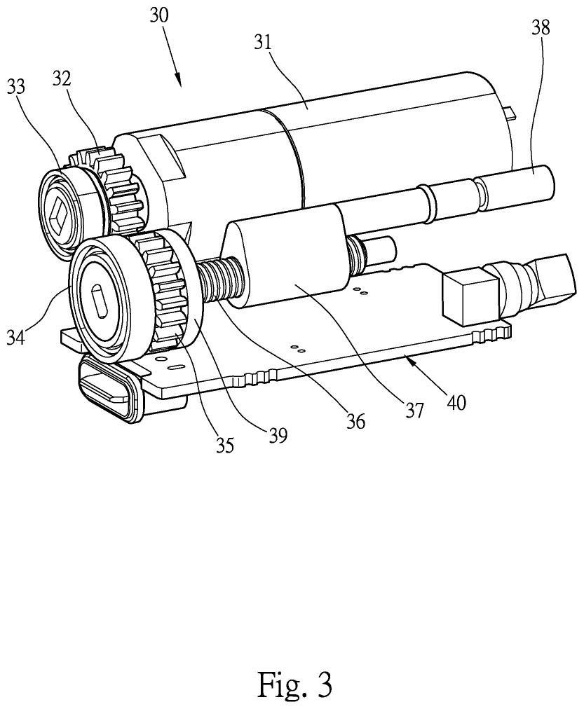

FIG. 3 illustrates an internal view of the actuator (30), which includes a DC motor (31), a motor gear (32), a motor bearing (33), a screw bearing (34), a screw gear (35), a lead screw (36), an actuator nut (37), an internal pushrod (38), a magnet ring (39), and a circuit board (40). This is an embodiment of a linear actuator used to drive the seat post (10) by hydraulic release. When the lead screw (36) rotates, it moves the actuator nut (37) towards the seat post, pushing one end of the internal pushrod (38), which in turn presses the hydraulic release button located at the bottom of the seat post. The magnet ring (39) is positioned near two Hall sensors on the circuit board. As the lead screw (36) rotates, the two Hall sensors detect the sinusoidal waves generated by the magnet ring. A magnetic induction translator on the circuit board (40) uses algorithms to accurately detect and calculate the precise position and speed of the actuator nut (37).

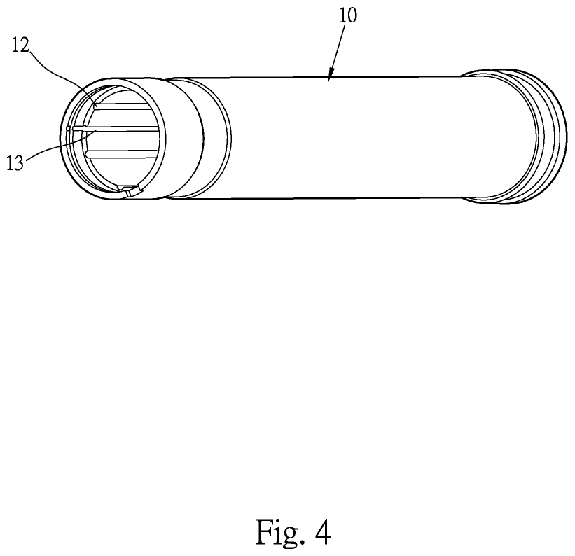

FIG. 4 is an internal view of the seat post (10) of the present invention. Inside the seat post (10), anti-rotation grooves (12) and an antenna cable channel (13) are visible. The present invention features multiple anti-rotation grooves (12) and an additional antenna cable channel (13) to allow the cable of the antenna (11) to pass through the seat post (10). The antenna cable channel (13) can be a simple round groove or have an undercut feature, allowing the cable to be pressed and fixed in place to facilitate connecting the antenna to the circuit board. Alternatively, the cable can be routed externally along the seat post (10), though this is not ideal as it is less attractive and more prone to damage.

The antenna (11) can use either a patch antenna or a chip antenna.

The present invention has the following advantages:

1. Unlike existing technologies, the actuator system is located at the bottom of the seat post, inside the bicycle frame.

2. The use of gear transmission allows the lead screw to be placed parallel to the motor to save space, or a small belt drive can be used to achieve the same function.

3. It includes a method for routing the antenna cable through the outer tube of the seat post, from the bottom of the seat post to the outside, where it can receive radio signals.

4. From the outside of the bicycle, it looks the same as a regular seat post.

5. It can be easily adjusted or retrofitted to current seat post designs with minimal modifications.

While we have shown and described the embodiment in accordance with the present invention, it should be clear to those skilled in the art that further embodiments may be made without departing from the scope of the present invention.

What is claimed is:

1. An actuator system for height adjustment of a bicycle seat post, comprising:
a motor (31);
a lead screw (36) driven by the motor (31);
an internal pushrod (38) connected to the lead screw (36), the internal pushrod (38) compresses a hydraulic release button at a bottom of the seat post;
an actuator housing (21) connected to the bottom of the seat post;
a circuit board (40) located inside the actuator housing (21) and including two Hall sensors, and a charged magnet ring (39) radially mounted on the lead screw (36), wherein the Hall sensors detect sinusoidal waves generated by the charged magnet ring (39) to determine a position of the lead screw (36).

2. The actuator system as claimed in claim 1, wherein the actuator system is entirely located within a bicycle frame.

3. The actuator system as claimed in claim 1, wherein an antenna (11) is connected to the circuit board (40) and extends outside of the bicycle frame.

4. The actuator system as claimed in claim 3, wherein the antenna (11) is a coaxial cable connected to a patch antenna.

5. The actuator system as claimed in claim 3, wherein the antenna (11) is a chip antenna.

6. The actuator system as claimed in claim 1, wherein the actuator system is installed in a bicycle seat tube with an inner diameter of 27 mm or larger.

7. The actuator system as claimed in claim 1, wherein the motor (31) and the lead screw (36) are parallel to each other, thereby saving space.

8. The actuator system as claimed in claim 1, wherein the motor (31) and the lead screw (36) are parallel, and the motor (31) is engaged with a screw gear (35) which drives the lead screw (36).

9. The actuator system as claimed in claim 1, wherein the actuator system has an attachment screw (23) so as to be fixed to the seat post.

10. The actuator system as claimed in claim 1, wherein a USB charging port (24) charges a battery associated with the actuator system, and a charging LED indicates a charging status.
